(19) United States
(12) Patent Application Publication
(10) Pub. No.: US 2007/0025242 A1
(43) Pub. Date: Feb. 1, 2007

(54) Dynamic allocation of aggregate buffer

(75) Inventor: Kwok Fai Tsang, Union City, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/189,847

(22) Filed: Jul. 27, 2005

(51) Int. Cl. H04L 12/26

(52) U.S. Cl. 370/229

(57) ABSTRACT

A dynamic congestion control apparatus and method are provided to receive data packets from source endpoints and outputting the data packets to destination endpoints. The dynamic congestion control apparatus and method include a congestion controller configured to determine and allocate additional buffer space for active channels based on total buffer space, a total number of channels per buffer, a minimum amount of buffer space of each channel distributed amongst all channels, and a number of active channels, and configured to adjust the additional buffer space for each active channel based on a corresponding drain rate.

### BACKGROUND OF THE INVENTION

1. Field of the Invention

The present invention relates to an apparatus and a method to dynamically allocate buffer space for multiple channels.

2. Description of the Related Art

An ideal network should be able to transmit useful traffic directly proportional to traffic offered to the network. Nonetheless, network operations diverge from an ideal network for a certain number of reasons which are all related to an inefficient allocation of resources in an overloaded environment. Congestion in packet networks may occur for example at routers where flows converge from different sources. As complicated networks may consist of numerous different end systems (sources and receivers), routers, and links, it is usually impossible to match their capacities perfectly. Accordingly, congestion will occur where more packets are received than can be handled.

Various ways of handling congestion are known. At the simplest level, buffering is provided to handle temporary overloads. For longer overloads, flow control mechanisms are provided, to enable downstream elements to cause a source of data packets to reduce the rate of sending packets. For instance, in the Internet, congestion is typically identified based on static queue thresholds or via a statistical average of a queue size (e.g., exponentially weighted moving average or EWMA). However, this type of identification is appropriate for systems with ample queuing, not when buffering resources are scarce.

Common solutions for buffer allocation provide having a centralized buffer space unallocated to a particular channel so that any and all channels can use the entire buffer space. However, if one of the channels uses up the entire buffer space, the other channels have to wait until the one of the channels is done using at least a portion the entire buffer space before having a chance to access such portion of the buffer space. Processing delays and significant congestion occurs when the one of the channels is a slow channel, thereby taking a significant amount of processing time to allow the other channels to use at least the portion of the buffer space, regardless if the other channels are faster channels than the one of the channels.

Another common solution includes dividing the entire buffer space into equal portions among all available channels. However, if only one channel is active and in need of additional buffer space, such channel does not have access to the remaining portions of the buffer space, regardless of whether the remaining channels are not active and/or in need of the remaining portions of the buffer space.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a single stage switch configuration device, in accordance with an embodiment of the present invention;

FIG. 2 illustrates a multi-stage switch configuration device, in accordance with an embodiment of the present invention;

FIG. 3 illustrates a configuration of a dynamic congestion control system to control congestion in multiple channels, in accordance with an embodiment of the present invention; and

FIG. 4 illustrates a method to adjust buffer space between active channels, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. The present invention described below provides a novel approach of controlling congestion in communication networks. A dynamic congestion control switch device is provided that is configured to allow allocation of available buffer space amongst active channels and is able to dynamically adjust the buffer space allocated to each active channel when the congestion control switch device is unbiased, based on a drain rate associated with each active channel.

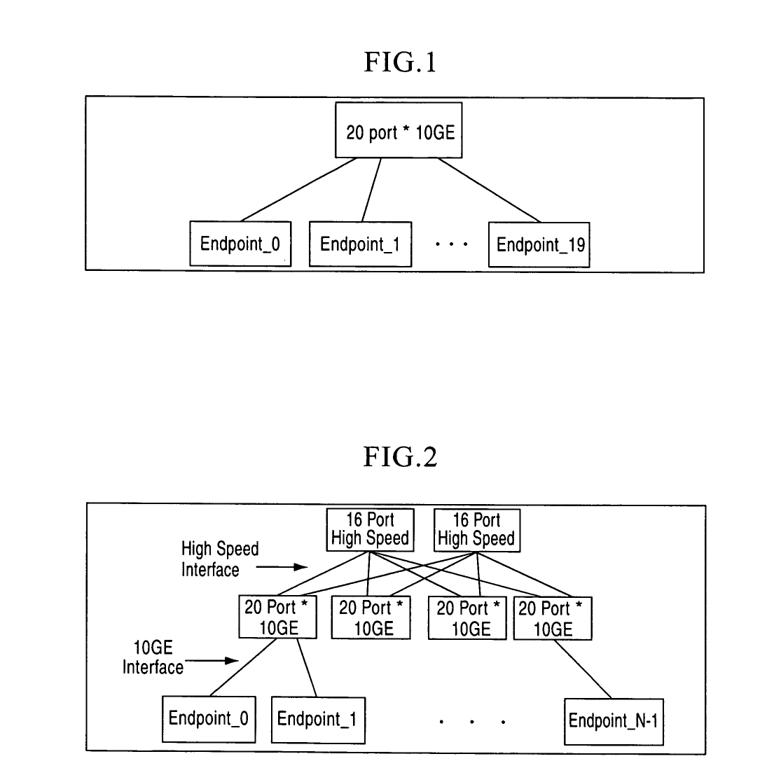

In accordance with an embodiment of the present invention, FIG. 1 illustrates a single-stage congestion control switch device is a high density port 10 GE switching device. In FIG. 1, a set of up to twenty endpoints may be connected to the single stage congestion control device. In an alternative embodiment of the present invention, the single-stage congestion control device may be used as a part of a multi-stage congestion control fabric configuration device as shown in FIG. 2. In the configuration of FIG. 2, a multiple-stage congestion control switch device is configured to be a sixteen port device including eight 10 GE ports facing the endpoints and eight high speed ports facing towards the second stage of the fabric. A high speed port is an interface that supports an updated version of a high speed port header format that enables ServiceAware Flow Control and congestion management schemes.

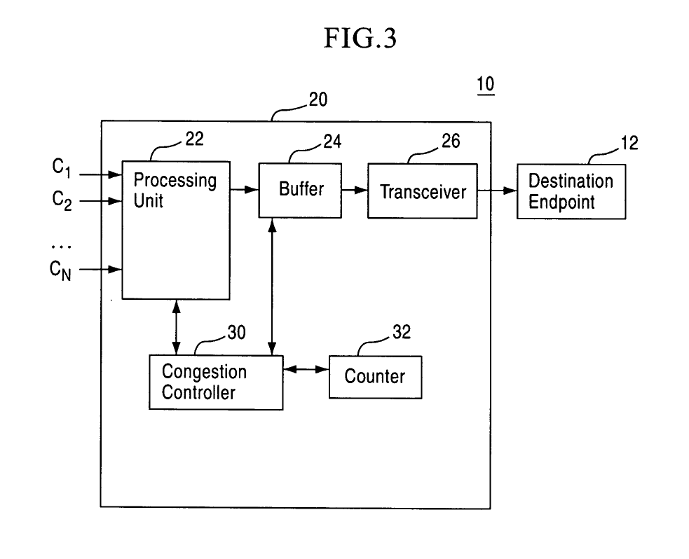

The single-stage congestion control switch device and the multiple-stage congestion control switch device aim to achieve intelligent fabric congestion control, which is a mechanism used to combat persistent congestion. FIG. 3 illustrates a configuration of a dynamic congestion control switch device 10 to control congestion in multiple channels, in accordance with an embodiment of the present invention. A congestion control apparatus 20 supports a plurality of logical data or channel connections (C₁, C₂, . . . C_{N}) between source endpoints and destination endpoints that are transmitting and receiving data packets, respectively. In accordance with an embodiment of the present invention, the congestion control apparatus 20 includes a processing unit 22 operatively connected to a buffer 24 and a congestion controller 30. The buffer 24 is operatively connected to the congestion controller 30 and a transceiver 26. In the congestion control apparatus 20, the congestion controller 30 is further operatively connected to a counter 32, where the counter 32 is provided per channel.

In operation, data packets, such as IP packets, are carried on each of the channel connections for transmission to a destination endpoint, which may include a mobile station for each channel. The data packets incoming to the congestion control apparatus 20 would be received through the channels by the processing unit 22 and transmitted by the transceiver 26 to a destination endpoint 12. Because the data packets generally are not immediately transmitted, some type of data buffering is needed. Data buffering in the buffer 24 may be arranged such that each one of the channels has its own data queue into which the corresponding data packets are buffered for scheduled transmission to the corresponding destination endpoint 12 through a packet data channel. The extent to which the available buffer space for each queue is occupied is generally termed the “buffer occupancy.” As the capacity limits of the packet data channel approaches, buffer occupancy rises.

In accordance with an embodiment of the present invention, the congestion controller 30 monitors buffer occupancy by determining the number of active channels and assigning additional buffer space to each active channel. The congestion controller 30 reduces congestion by monitoring the active channels and allowing those active channels to effectively utilize buffer space.

For instance, the congestion controller 30 measures a total amount of buffer space available per buffer and determines the total number of channels available per buffer 24. The congestion controller 30 proceeds to allocate a minimum amount of buffer space of each channel distributed amongst all channels. The minimum amount of buffer space of each channel distributed amongst all channels may be set-up during system initialization or may be adjusted during system operation and may vary depending on a particular application. For instance, each channel or buffer entry would be assigned a minimum amount of bytes based on a total amount of bytes per buffer 24.

Because the minimum amount of buffer space is assigned to each channel, the congestion controller 30 is able to detect when the data packets begin to flow through a particular channel to the processing unit 22, thereby the congestion controller 30 is able to monitor the particular channel and determine whether additional buffer space is needed—by the particular channel to avoid congestion. During operation, the congestion controller 30 dynamically, that is, automatically, without user intervention, monitors and determines active channel or channels. An active channel is defined as a channel currently receiving and passing through the data packets. For each active channel, the congestion controller continuously measures an associated drain rate. The drain rate is defined as a nominal constant traffic rate for constant data bit rate streams or a piece-wise computed traffic rate of variable rate media stream packet data. Subsequently, the congestion controller 30 proceeds to compute and assign additional buffer space to each active channel. In accordance with an embodiment of the present invention, a relationship that the congestion controller 30 may implement to determine the additional buffer space per active channel is the following:
A_{BUFFER}=(B_{T}−N_{T}*M_{T})/CH_{A} (1)

where A_{BUFFER} is the additional buffer space per active channel to be assigned, B_{T} is a total buffer space, N_{T} is a total number of channels, active or inactive, M_{T} is the minimum buffer space allocated for each channel distributed amongst all channels, active and inactive, and CH_{A} is the number of active channels. Once the congestion controller 30 determines the additional buffer space A_{BUFFER}, the congestion controller 30 proceeds to assign the additional buffer space to each active channel.

The congestion controller 30 also adjusts the additional buffer space A_{BUFFER} per active channel based on the drain rate corresponding to each active channel. Specifically, although ideally the active channels could be able to output the data packets at a same rate, at times, there are occasions were some active channels may be able to output the data packets at a higher drain rate than the other active channels, such as a consumer of data being external. Because of the different drain rates, the congestion control apparatus 20 is implemented to be able to compensate for the difference in drain rates by adjusting the additional buffer space A_{BUFFER} per active channel to be directly proportional to the drain rate of each corresponding active channel. In one embodiment, the active channel that drains faster may be given more buffer space to its additional buffer space A_{BUFFER} of that channel.

To compensate for the difference in drain rates, in accordance with an embodiment of the present invention, once the additional buffer space A_{BUFFER} is determined and allocated for each active channel and the congestion control apparatus 20 is unbiased, the congestion controller 30 measures the drain rate of each active channel over a preset or programmable period of time or for a preset number of cycles. Over the preset period of time for measurement, the active channel that drains faster may be given more buffer space to its additional buffer space A_{BUFFER} to work with. A counter 32 is provided per channel to measure the drain rate or the data packets being output from the buffer. The counter 32 is triggered only for those active channels and counts the data being output from each particular active channel for the preset period of time so that the congestion controller 30 may determine the drain rate of each particular active channel. The congestion controller 30 compares the drain rates determined for the active channel and adjusts the additional buffer space A_{BUFFER} for each active channel based on the associated drain rate. Thus, even though the additional buffer space A_{BUFFER} may not be equally divided among the active channels due to the different drain rates amongst the active channels, the congestion controller 30 allows an initial equal allocation of additional buffer space A_{BUFFER} between the active channels to begin resolving congestion in the buffer 24, thereby saving time and reducing the amount of congestion.

For instance, the congestion control switch device 10 may include five (5) channels sharing the buffer 24. In the beginning, each channel is given a minimal amount of buffer space that may vary depending on a specific application or implementation. Assuming that the minimal amount of buffer space per channel is assigned and only one (1) channel is detected as being active, the one channel would eventually get all the addition buffer space to be assigned. If at a subsequent point in time, the congestion controller 30 determines that two (2) additional channels are now active, the congestion controller 30 would re-calculate the additional buffer space A_{BUFFER} based on the number of active channels CH_{A}, which in this instance is equal to three (3) total active channels. As the additional buffer space A_{BUFFER} originally allocated to the only one channel is freed, based on the re-calculated additional buffer space A_{BUFFER}, the freed buffer space would then be distributed to the two additional channels now active. The congestion control apparatus 20 is unbiased if the additional buffer space A_{BUFFER} may be distributed among all active channels (e.g., three channels in this instance) equally.

To illustrate the above, the congestion control apparatus 20 includes five (5) channels sharing the buffer 24, the total buffer space, for instance, is equal to 15 Kbytes, the minimum buffer space distributed amongst all channels, active and inactive, M_{T} is equal to 1 Kbytes and the number of active channels CH_{A} is equal to two (2). Based on Equation (1), the following applies:
A_{BUFFER}=(B_{T}−N_{T}*M_{T})/CH_{A}=(15−5*1)/2=5 Kbytes (2)

Thus, the additional buffer space A_{BUFFER} for each active channel is equal to 5 Kbytes. Once the congestion control apparatus 20 is unbiased, the congestion controller 30 measures the drain rate of each active channel over a preset period of time. If the drain rates for the active channels are the same, then the additional buffer space A_{BUFFER} for each active channel remains to be equal to 5 Kbytes. However, if the drain rates between the active channels are different and, for illustrative purposes, if the drain rate of the first active channel is determined to be equal to 2 Kbytes/sec and the drain rate of the second active channel is equal to 3 Kbytes/sec, then the congestion controller 30 compares the drain rates determined for the active channel and adjusts the additional buffer space for each active channel based on the associated drain rate. Specifically, the congestion controller 30 adjusts the additional buffer space for the first active channel using the following relationship:
A_{BUFFER} is proportional to [(B_{T}−N_{T}*M_{T})/CH_{A}]*Drain Rate (3)

Thus, for the first active channel, the congestion controller 30 would allocate 4 Kbytes of additional buffer space and, for the second active channel the congestion controller 30 would allocate 6 Kbytes of additional buffer space A_{BUFFER}.

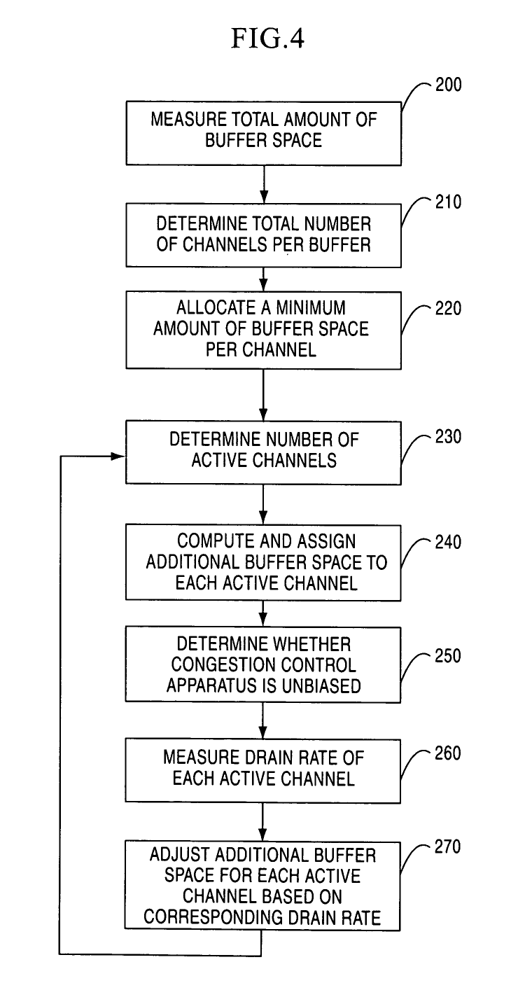

FIG. 4 illustrates a method to adjust buffer space between active channels, in accordance with an embodiment of the present invention. At operation 200, the method measures the total amount of buffer space B_{T} available per buffer 24. At operation 210, the method determines the total number of channels N_{T} available per buffer 24. At operation 220, the method allocates a minimum amount of buffer space M_{T} of each channel distributed amongst all channels. As previously indicated, the minimum amount of buffer space M_{T} may vary depending upon the particular application, the available buffer space A_{BUFFER} per buffer 24, and/or the total number of channels CH_{A} available per buffer 24. The minimum amount of buffer space M_{T} of each channel distributed amongst all channels may be set-up during system initialization or may be adjusted during system operation. At operation 230, as the data packets are received, the method determines the number of active channels CHA per buffer 24. At operation 240, the method computes and assigns additional buffer space A_{BUFFER} to each active channel.

Once the method determines and allocates the additional buffer space A_{BUFFER} for each active channel, at operation 250, the method determines whether the congestion control apparatus 20 is unbiased. At operation 260, the method measures the drain rate of each active channel over a preset or programmable period of time or for a preset number of cycles. The preset period of time or the preset number of cycles may be set-up during system initialization or may be adjusted during system operation. At operation 270, based on the drain rate measured for each active channel, the method adjusts the additional buffer space A_{BUFFER} for each active channel. After operation 270, the method returns to operation 230 to continuously monitor the active channels, the drain rate of each active channel, and the assignment of additional buffer space to each active channel based on the drain rate corresponding to each active channel.

In accordance with an embodiment of the present invention, a dynamic congestion control apparatus and method are provided allowing a dynamic and continuous monitoring, determination, and adjustment of available buffer space amongst active channels in a buffer. The dynamic congestion control apparatus avoids starvation of fast channels by reducing the available buffer space to slow active channels based on a drain rate measurement.

It is to be understood that in the embodiment of the present invention, the operations are performed in the sequence and manner as shown although the order of some operations and the like may be changed without departing from the spirit and scope of the present invention.

In addition, while the term data packet has been used in the description of the present invention, the invention has import to many types of network data. For purposes of this invention, the term packet includes packet, cell, frame, datagram, bridge protocol data unit packet, packet data and any equivalents thereof.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A dynamic congestion control apparatus receiving data packets from source endpoints and outputting the data packets to destination endpoints, comprising:
a congestion controller configured to determine and allocate additional buffer space for active channels based on total buffer space, a total number of channels per buffer, a minimum amount of buffer space of each channel distributed amongst all channels, and a number of active channels, and configured to adjust the additional buffer space for each active channel based on a corresponding drain rate.

2. The dynamic congestion control apparatus as recited in claim 1, wherein the congestion controller is configured to measure the drain rate associated with each active channel.

3. The dynamic congestion control apparatus as recited in claim 1, further comprising:
a processing unit configured to receive the data packets through a plurality of logical data or channel connection;
a buffer; and
a transceiver, wherein the buffer is configured to provide to each channel a data queue into which corresponding data packets are buffered for scheduled transmission to a corresponding destination endpoint.

4. The dynamic congestion control apparatus as recited in claim 1, wherein the minimum amount of buffer space of each channel distributed amongst all channels is set-up during the congestion control apparatus initialization or during operation.

5. The dynamic congestion control apparatus as recited in claim 1, wherein the congestion controller detects when the data packets begin to flow through a particular channel using the minimum amount of buffer space of each channel distributed amongst all channels.

6. The dynamic congestion control apparatus as recited in claim 1, wherein the congestion controller continuously measures the drain rate corresponding to each active channel.

7. The dynamic congestion control apparatus as recited in claim 1, wherein the drain rate is a nominal constant traffic rate for constant data bit rate streams through the active channel or a piece-wise computed traffic rate of variable rate media stream packet data through the active channel.

8. The dynamic congestion control apparatus as recited in claim 1, wherein the congestion controller computes and assigns the additional buffer space to each active channel using the following relationship
A_{BUFFER}=(B_{T}−N_{T}*M_{T})/CHA
where A_{BUFFER} is the additional buffer space per active channel, B_{T} is the total buffer space, N_{T} is the total number of channels, active or inactive, M_{T} is the minimum buffer space of each channel distributed amongst all channels, active and inactive, and CH_{A} is the number of active channels.

9. The dynamic congestion control apparatus as recited in claim 1, wherein the adjusted additional buffer space allocated to each active channel is directly proportional to the drain rate corresponding to each active channel.

10. The dynamic congestion control apparatus as recited in claim 1, wherein after determining the additional buffer space and the congestion control apparatus is unbiased, the congestion controller measures the drain rate of each active channel over a preset or programmable period of time or for a preset number of cycles.

11. The dynamic congestion control apparatus as recited in claim 1, wherein the congestion controller further comprises a counter per channel configured to count the data packets being output from each particular active channel for a preset period of time providing a count value per the preset period of time to the congestion controller to determine the drain rate of each active channel.

12. The dynamic congestion control apparatus as recited in claim 1, wherein the congestion controller adjusts the additional buffer space for each active channel using the following relationship:
A_{BUFFER} is proportional to [(B_{T}−N_{T}*M_{T})/CH_{A}]*Drain Rate
where A_{BUFFER} is the additional buffer space per active channel, B_{T} is the total buffer space, N_{T} is the total number of channels, active or inactive, M_{T} is the minimum buffer space of each channel distributed amongst all channels, active and inactive, and CH_{A} is the number of active channels, and the Drain Rate is the drain rate corresponding to each active channel.

13. A dynamic congestion control method, comprising:
receiving data packets from source endpoints and outputting the data packets to destination endpoints;
determining and allocating additional buffer space for active channels based on total buffer space, a total number of channels per buffer, a minimum amount of buffer space of each channel distributed amongst all channels, and a number of active channels; and
adjusting the additional buffer space for each active channel based on a corresponding drain rate.

14. The dynamic congestion control method as recited in claim 13, further comprising:
measuring the drain rate associated with each active channel.

15. The dynamic congestion control method as recited in claim 13, further comprising:
setting the minimum amount of buffer space of each channel distributed amongst all channels during initialization or during operation.

16. The dynamic congestion control method as recited in claim 13, further comprising:
processing the minimum amount of buffer space of each channel distributed amongst all channels to detect when the data packets begin to flow through a particular channel.

17. The dynamic congestion control method as recited in claim 13, further comprising:
continuously measuring the drain rate corresponding to each active channel.

18. The dynamic congestion control method as recited in claim 13, further comprising:
measuring the drain rate as a nominal constant traffic rate for constant data bit rate streams through the active channel or a piece-wise computed traffic rate of variable rate media stream packet data through the active channel.

19. The dynamic congestion control method as recited in claim 13, further comprising:
computing and assigning the additional buffer space to each active channel using the following relationship
A_{BUFFER}=(B_{T}−N_{T}*M_{T})/CH_{A},
where A_{BUFFER} is the additional buffer space per active channel, B_{T} is the total buffer space, N_{T} is the total number of channels, active or inactive, M_{T} is the minimum buffer space of each channel distributed amongst all channels, active and inactive, and CH_{A} is the number of active channels.

20. The dynamic congestion control method as recited in claim 13, further comprising:
allocating the adjusted additional buffer space to each active channel to be directly proportional to the drain rate corresponding to each active channel.

21. The dynamic congestion control method as recited in claim 13, wherein after determining the additional buffer space and the congestion control apparatus is unbiased, the method further comprises
measuring the drain rate of each active channel over a preset or programmable period of time or for a preset number of cycles.

22. The dynamic congestion control method as recited in claim 13, further comprising:
counting a counter per channel to measure the drain rate or the data packets being output from each particular active channel for a preset period of time; and
generating a count value per the preset period of time to determine the drain rate of each active channel.

23. The dynamic congestion control method as recited in claim 13, further comprising:
adjusting the additional buffer space for each active channel using the following relationship:
A_{BUFFER} is proportional to [(B_{T}−N_{T} *M_{T})/CH_{A}]*Drain Rate
where A_{BUFFER} is the additional buffer space per active channel, B_{T} is the total buffer space, N_{T} is the total number of channels, active or inactive, M_{T} is the minimum buffer space of each channel distributed amongst all channels, active and inactive, and CH_{A} is the number of active channels, and the Drain Rate is the drain rate corresponding to each active channel.

24. A dynamic congestion control apparatus receiving data packets from source endpoints and outputting the data packets to destination endpoints, comprising:
congestion controller means for determining and allocating additional buffer space for active channels based on total buffer space, a total number of channels per buffer, a minimum amount of buffer space of each channel distributed amongst all channels, and a number of active channels, and configured to adjust the additional buffer space for each active channel based on a corresponding drain rate.
